(19) United States
(12) Patent Application Publication
(10) Pub. No.: US 2026/0279883 A1
(43) Pub. Date: Sep. 17, 2026

(54) CONDUCTIVE MODULE

(71) Applicants: YAZAKI CORPORATION, Tokyo (JP); Prime Planet Energy & Solutions, Inc., Tokyo (JP)

(72) Inventors: Yasuhiro Kominato, Makinohara-shi (JP); Katsunori Sato, Makinohara-shi (JP); Go Yamashiro, Miyoshi-shi (JP)

(21) Appl. No.: 19/567,406

(22) Filed: Mar. 16, 2026

(30) Foreign Application Priority Data
Mar. 17, 2025 (JP) 2025-042013

(51) Int. Cl. H01M 10/04; H01M 10/48; H01M 50/209; H01M 50/262; H01M 50/298; H01M 50/507

(52) U.S. Cl. CPC H01M 10/0481; H01M 10/482; H01M 10/486; H01M 50/209; H01M 50/262; H01M 50/298; H01M 50/507

(57) ABSTRACT

A conductive module includes a wiring component, a temperature sensor unit, a pressing member, and a housing member, in which the temperature sensor unit includes a temperature detection branch body of the wiring component, a temperature sensor physically and electrically connected to a temperature detection conductor portion of the temperature detection branch body, and a frame-shaped frame member arranging the temperature sensor on the inner side thereof such that the temperature sensor is surrounded by the frame member, the pressing member includes a pair of locked portions disposed to face each other with a space therebetween, and a pressing portion provided on a virtual line connecting the pair of locked portions and configured to press the temperature sensor unit against a battery cell.

### CROSS-REFERENCE TO RELATED APPLICATION(S)

The present application claims priority to and incorporates by reference the entire contents of Japanese Patent Application No. 2025-042013 filed in Japan on Mar. 17, 2025.

### BACKGROUND OF THE INVENTION

### 1. Field of the Invention

The present invention relates to a conductive module.

### 2. Description of the Related Art

In the related art, a battery pack for supplying power to a rotary machine serving as a drive source is mounted in a vehicle such as an electric vehicle. The battery pack includes a battery module obtained by arranging a plurality of battery cells therein, and a conductive module that electrically connects the respective battery cells and transmits information on battery states of the battery cells to a battery monitoring unit. The conductive module is provided with a temperature sensor unit for detecting a temperature of the battery cell, and a pressing member for pressing the temperature sensor unit against the battery cell to increase temperature detection accuracy of the battery cell. The pressing member includes a rectangular parallelepiped pressing portion adapted to place a lower portion thereof against the temperature sensor unit, and a pair of cantilevered flexible arms adapted to apply pressing force from the pressing portion to the temperature sensor unit by applying force resulting from bending deformation of the flexible arms to an upper portion of the pressing portion. For example, this type of conductive module is disclosed in Japanese Patent Application Laid-open No. 2022-79018.

Meanwhile, in a pressing member of the related art, in order to generate pressing force to a temperature sensor unit with an appropriate magnitude, a bending amount of a flexible arm is secured by stacking a pressing portion and a pair of the flexible arms in an action direction of the pressing force. Therefore, in the conductive module of the related art, the pressing member causes an increase in size in the action direction of the pressing force, that may hinder reduction in height.

### SUMMARY OF THE INVENTION

Therefore, an object of the present invention is to provide a conductive module capable of reducing a size of a pressing member in an action direction of pressing force.

A conductive module according to one aspect of the present invention includes a wiring component provided with a plurality of conductor portions electrically connecting a battery module to a battery monitoring unit, the battery module having a plurality of battery cells arranged therein in a row, the battery monitoring unit being configured to monitor battery states of the battery cells; a temperature sensor unit configured to detect a temperature of the battery cell; a plate-shaped pressing member configured to press the temperature sensor unit against the battery cell; and a housing member configured to house therein the wiring component, the temperature sensor unit, and the pressing member, wherein the wiring component includes a wiring main body extending in an arrangement direction of the battery cells, a temperature detection branch body branching from the wiring main body toward the battery cell as a temperature detection target, and a temperature detection conductor portion serving as the conductor portion, the temperature detection conductor portion being electrically connected to the temperature sensor unit, the temperature sensor unit includes the temperature detection branch body, a temperature sensor physically and electrically connected to the temperature detection conductor portion of the temperature detection branch body, and a frame-shaped frame member configured for the temperature sensor to be disposed on an inner side thereof such that the temperature sensor is surrounded by the frame member, the pressing member includes a pair of locked portions disposed to face each other with a space therebetween, and a pressing portion provided on a virtual line connecting the pair of locked portions, the pressing portion pressing the temperature sensor unit against the battery cell, and the housing member includes, for each locked portion, a locking portion adapted to lock the locked portion in a state in which the pressing portion is in contact with the temperature sensor unit and the temperature sensor unit is in contact with the battery cell, the locking portion being adapted to apply pressing force toward the battery cell to the locked portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a conductive module according to an embodiment;

FIG. 2 is an exploded perspective view illustrating the conductive module according to the embodiment;

FIG. 3 is an exploded perspective view extracting a main part of the conductive module according to the embodiment;

FIG. 4 is a perspective view illustrating a main part of the conductive module according to the embodiment;

FIG. 5 is an exploded perspective view extracting a main part of the conductive module according to the embodiment;

FIG. 6 is a cross-sectional view taken along line X-X illustrated in FIG. 4;

FIG. 7 is an explanatory diagram for description of a battery module;

FIG. 8 is a perspective view illustrating a pressing member;

FIG. 9 is a perspective view of the pressing member when viewed from another angle;

FIG. 10 is a plan view for description of the pressing member;

FIG. 11 is a perspective view illustrating a modification of the pressing member;

FIG. 12 is a perspective view of the modification of the pressing member when viewed from another angle; and

FIG. 13 is a plan view for description of the modification of the pressing member.

### DETAILED DESCRIPTION OF THE PREFERRED EMBODIMENTS

Hereinafter, an embodiment of a conductive module according to the present invention will be described in detail with reference to the drawings. It is noted that the present invention is not limited by the embodiment.

### Embodiment

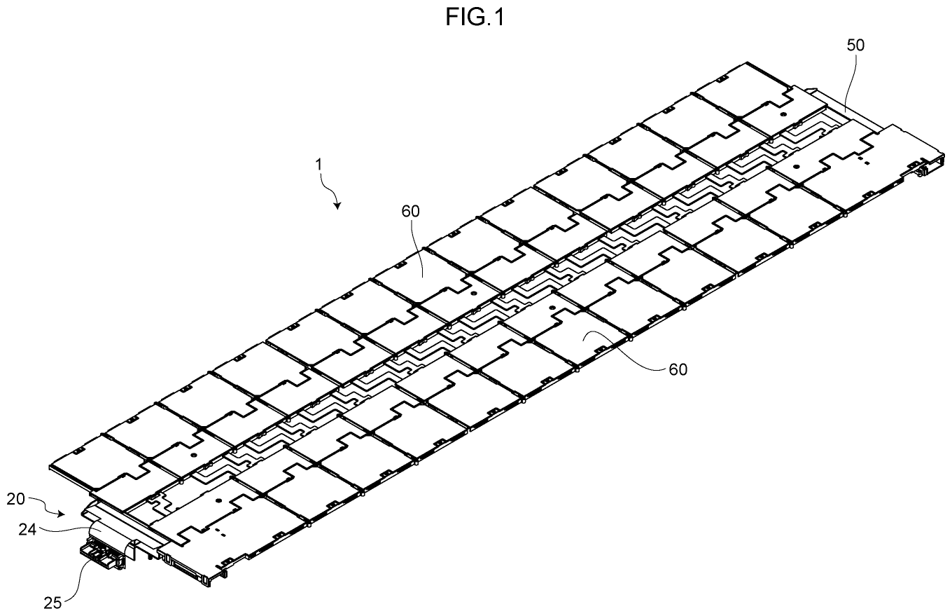

One of the embodiments of a conductive module according to the present invention will be described with reference to FIGS. 1 to 13.

Reference numeral 1 in FIGS. 1 to 6 denotes a conductive module according to the present embodiment. The conductive module 1 is assembled with a battery module BM (FIG. 7) in which a plurality of battery cells BC are arranged in a row. The conductive module 1 electrically connects the plurality of battery cells BC in the battery module BM. In addition, the conductive module 1 electrically connects the battery module BM to a battery monitoring unit (not illustrated) that monitors a battery state of the battery cell BC, thereby causing the battery monitoring unit to monitor the battery state (voltage, temperature, and the like) of the battery cell BC. The conductive module 1 forms a battery pack BP together with the battery module BM (FIG. 7). The battery pack BP is mounted on, for example, a vehicle (battery electric vehicle (BEV), HEV: hybrid electric vehicle (HEV), and the like) including a rotary machine as a drive source, and is used to supply power to the rotary machine. A configuration of the battery module BM in the drawing, such as the number of battery cells BC, is simplified for convenience of description.

The battery cell BC includes a cell body BCa and positive and negative electrode terminals BCb (FIG. 7). In the battery cell BC illustrated here, the cell body BCa is formed in a rectangular parallelepiped shape having six outer wall surfaces. In the plurality of battery cells BC forming the battery module BM, the cell bodies BCa adjacent to each other in an arrangement direction are arranged with their single outer wall surfaces facing each other. The battery module BM includes one electrode terminal group BCc in which one electrode terminal BCb of each battery cell BC is arranged in the arrangement direction, and the other electrode terminal group BCd in which the other electrode terminal BCb of each battery cell BC is arranged in the arrangement direction (FIG. 7).

Hereinafter, in a case in which term “arrangement direction” is described while not particularly mentioned, the term refers to the arrangement direction of the plurality of battery cells BC and the arrangement direction of the plurality of electrode terminals BCb in the electrode terminal groups BCc and BCd.

In this example, each battery cell BC includes positive and negative electrode terminals BCb on one of the six outer wall surfaces of the cell body BCa (FIG. 7). Therefore, in the battery module BM, two electrode terminal groups BCc and BCd are provided on one flat surface (FIG. 7).

In addition, the electrode terminal BCb illustrated here is formed in a flat plate shape and is physically and electrically connected to a plate-shaped bus bar 10 to be described later by welding or the like (FIG. 7). The electrode terminal BCb may be formed in a pole shape having a male screw portion. In this case, the bus bar 10 is screwed and fixed to the electrode terminal BCb by screwing a female screw member to the male screw portion of the electrode terminal BCb. However, from the viewpoint of reducing a height of the battery pack BP, desirably, the electrode terminal BCb has a flat plate shape to which the bus bar 10 is connected by welding or the like.

The conductive module 1 includes the bus bar 10, a wiring component 20, a temperature sensor unit 30, and a pressing member 40 (FIGS. 1 to 6). The conductive module 1 includes a housing member 50 that houses the bus bar 10, the wiring component 20, the temperature sensor unit 30, and the pressing member 40 (FIGS. 1 to 6). The housing member 50 is formed of an insulating material such as synthetic resin, and is placed and installed on the battery module BM.

The bus bar 10 is a plate-shaped conductive member for terminal connection that is physically and electrically connected to the electrode terminal BCb of one or a pair of battery cells BC in the battery module BM. The bus bar 10 is formed of a conductive material such as metal. For example, the bus bar 10 is press-molded using a metal plate as a base material. The bus bar 10 illustrated here is formed in a rectangular shape and is physically and electrically connected to the electrode terminal BCb by laser welding.

As the bus bar 10, a bus bar that is physically and electrically connected to one electrode terminal BCb serving as a total negative electrode in the battery module BM, and a bus bar that is physically and electrically connected to one electrode terminal BCb serving as a total positive electrode in the battery module BM are provided. Further, as the bus bar 10, a bus bar that is physically and electrically connected to the electrode terminals BCb adjacent to each other in the arrangement direction of the pair of battery cells BC in the battery module BM is provided.

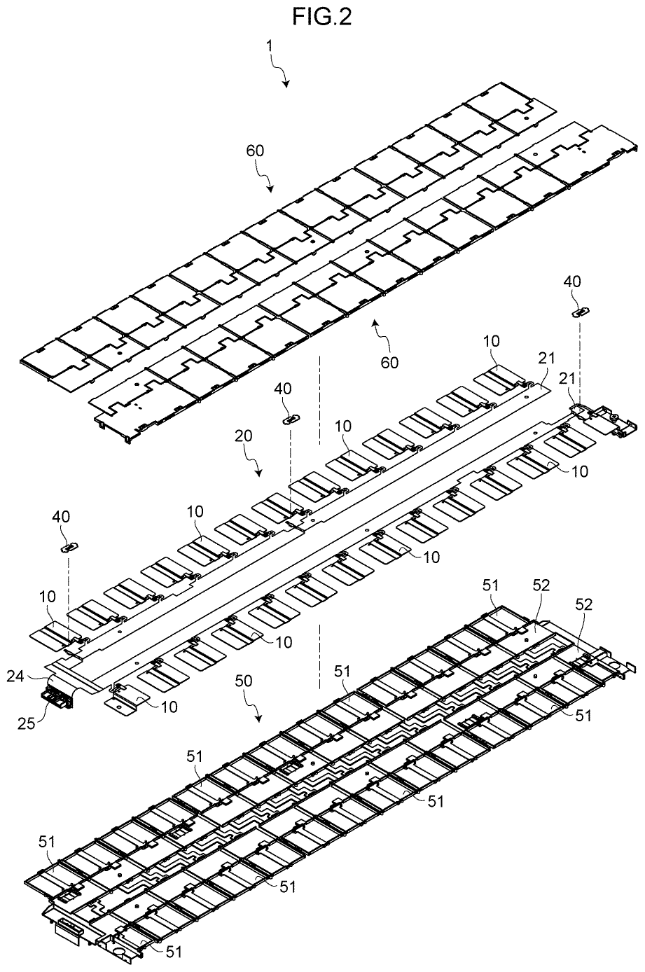

In the housing member 50, a bus bar housing chamber 51 for housing the bus bar 10 is formed for each bus bar 10 (FIGS. 2 to 5). The bus bar 10 is physically and electrically connected to the electrode terminal BCb in the bus bar housing chamber 51.

The wiring component 20 is a component provided to electrically connect the battery module BM to the battery monitoring unit.

The wiring component 20 is provided with a plurality of conductor portions (not illustrated) for electrically connecting the battery module BM to the battery monitoring unit. The wiring component 20 includes, as the conductor portion, a conductor portion (hereinafter, referred to as a “voltage detection conductor portion”) for each bus bar 10, that electrically connects the bus bar 10 to the battery monitoring unit and causes the battery monitoring unit to monitor the voltage of the battery cell BC to which the bus bar 10 is connected. Further, the wiring component 20 includes a conductor portion (hereinafter, referred to as a “temperature detection conductor portion”) for causing the battery monitoring unit to monitor the temperature of the battery cell BC as the conductor portion. The temperature detection conductor portion is electrically connected to the temperature sensor unit 30 to be described later, thereby electrically connecting the temperature sensor unit 30 to the battery monitoring unit.

The wiring component 20 illustrated here is a flexible wiring component that is formed flat with flexibility, and includes a plurality of conductor portions and an insulating coating that encloses the plurality of conductor portions. The wiring component 20 in this example is a flexible printed circuit (FPC) board including patterns (so-called conductor patterns) of a plurality of circuit conductors to be conductor portions. The wiring component 20 includes, as the insulating coating, various films (base film and cover film) formed flat with flexibility, and a conductor pattern is formed on at least one (base film) of the various films. The conductor pattern is enclosed by the insulating coating, and for example, a location to be an electrical contact point with another component is exposed.

The wiring component 20 includes a wiring main body 21 extending in the arrangement direction, a branch body (hereinafter, referred to as a “voltage detection branch body”) 22 branching from the wiring main body 21 toward the bus bar 10, and a branch body (hereinafter, referred to as a “temperature detection branch body”) 23 branching from the wiring main body 21 toward the battery cell BC as a temperature detection target (FIGS. 2 to 5). In the wiring component 20, the voltage detection conductor portion is routed between the wiring main body 21 and the voltage detection branch body 22, and the temperature detection conductor portion is routed between the wiring main body 21 and the temperature detection branch body 23.

The wiring main body 21 illustrated here is formed in a rectangular flat plate shape and is disposed between the two electrode terminal groups BCc and BCd in the battery module BM. The wiring component 20 illustrated here has the wiring main body 21 for each of the electrode terminal groups BCc and BCd, and ends of the two wiring main bodies 21 are connected to each other by a coupling body 24 (FIGS. 1 and 2). A connector 25 to be fitted and connected to a connector on the battery monitoring unit side is connected to the coupling body 24 (FIGS. 1 and 2). The connector 25 includes a terminal fitting (not illustrated) for each voltage detection conductor portion that is physically and electrically connected to one end of the voltage detection conductor portion of the coupling body 24, and a terminal fitting (not illustrated) for each temperature detection conductor portion that is physically and electrically connected to one end of the temperature detection conductor portion of the coupling body 24.

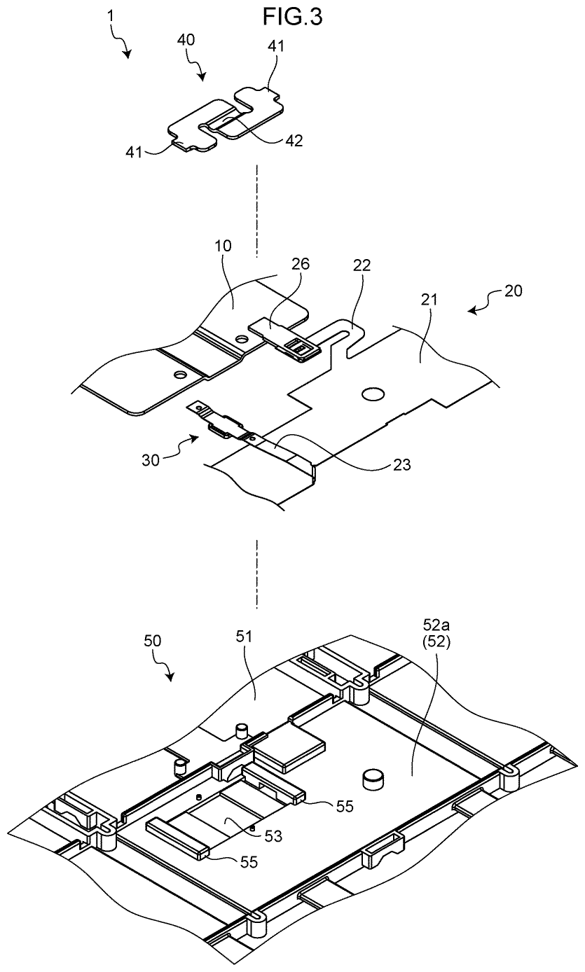

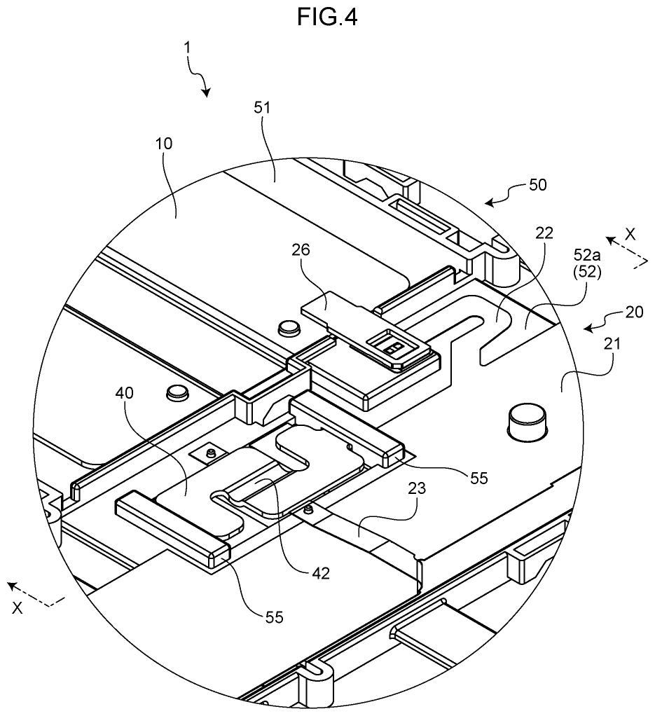

The voltage detection branch body 22 is provided for each bus bar 10. An intermediate connection member 26 such as a metal conductive member is interposed between the voltage detection branch body 22 and the bus bar 10 (FIGS. 3 and 4). The intermediate connection member 26 is physically and electrically connected to the voltage detection conductor portion of the voltage detection branch body 22 and the bus bar 10 by, for example, laser welding or the like, and electrically connects the voltage detection conductor portion to the bus bar 10.

Further, the temperature detection branch body 23 does not need to be provided for each bus bar 10. The temperature detection branch body 23 illustrated here is provided for a battery cell BC selected as a temperature detection target from among the respective battery cells BC. The temperature sensor unit 30 is electrically connected to the temperature detection conductor portion of the temperature detection branch body 23.

In the housing member 50, a wiring housing chamber 52 for housing the wiring component 20 is formed (FIGS. 2 to 6). The wiring housing chamber 52 is provided for each wiring main body 21.

The temperature sensor unit 30 is a component for detecting the temperature of the battery cell BC and is brought into contact with the battery cell BC. Here, the temperature sensor unit 30 on the outer wall surface of the cell body BCa provided with the positive and negative electrode terminals BCb is brought into contact. The pressing member 40 is a plate-shaped member that presses the temperature sensor unit 30 against the battery cell BC in order to keep the temperature sensor unit 30 in contact with the battery cell BC.

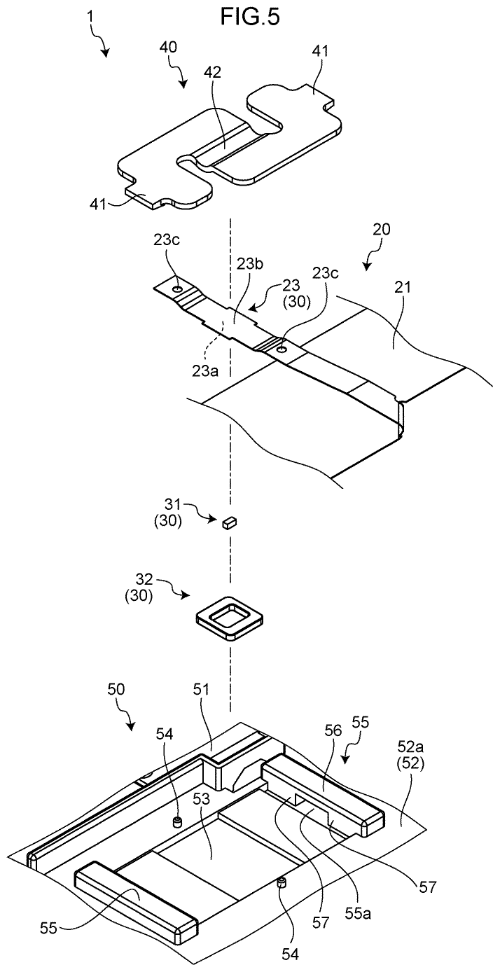

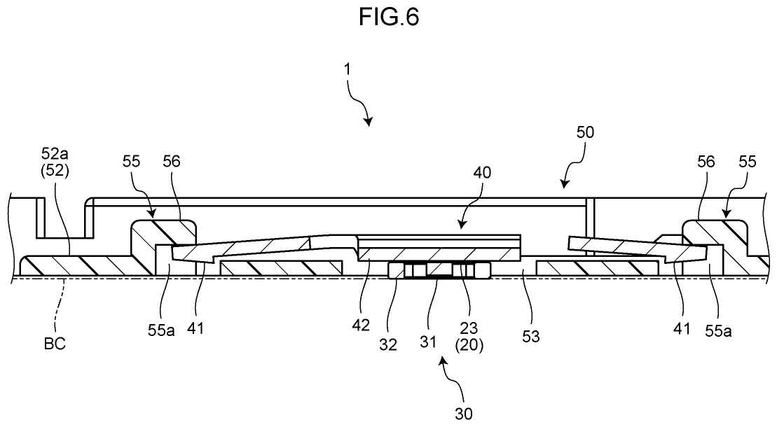

The temperature sensor unit 30 includes the temperature detection branch body 23, a temperature sensor 31 physically and electrically connected to the temperature detection conductor portion of the temperature detection branch body 23, and a frame-shaped frame member 32 formed for the temperature sensor 31 to be disposed on the inner side thereof such that the temperature sensor 31 is surrounded by the frame member 32 (FIGS. 5 and 6).

The temperature detection branch body 23 is disposed such that one flat surface 23a (FIG. 5) faces the outer wall surface of the cell body BCa in the battery cell BC. The temperature sensor 31 is mounted on one flat surface 23a of the temperature detection branch body 23. Here, the temperature detection conductor portion is exposed on the one flat surface 23a, and the temperature sensor 31 is physically and electrically connected to the temperature detection conductor portion by soldering or the like. The temperature sensor 31 illustrated here is a chip thermistor.

The frame member 32 is assembled with one flat surface 23a of the temperature detection branch body 23 in a state in which the temperature sensor 31 is disposed inside the frame member 32. The frame member 32 is, for example, a heat transfer member formed in a rectangular frame shape using a metal material having high thermal conductivity such as copper. The temperature sensor unit 30 brings the frame member 32 into contact with the outer wall surface of the cell body BCa in the battery cell BC.

The frame member 32 receives heat of the cell body BCa, dissipates the heat into the frame, and transmits the heat to the temperature detection branch body 23. The temperature sensor 31 detects a temperature corresponding to the heat in the frame of the frame member 32 and the heat of the temperature detection branch body 23 as the temperature of the cell body BCa.

The pressing member 40 is formed in a plate shape using a metal plate or the like having springiness. The springiness refers to, for example, a property of returning to an original shape by removing a load even if deformation occurs by application of the load. The pressing member 40 covers the temperature sensor unit 30 in contact with the battery cell BC.

The pressing member 40 includes a pair of locked portions 41 arranged to face each other with a space therebetween, and a pressing portion 42 provided on a virtual line VL connecting the pair of locked portions 41 and formed to press the temperature sensor unit 30 against the battery cell BC (FIGS. 3, 5, 6, and 8 to 10). The pressing member 40 locks the pair of locked portions 41 and applies pressing force toward the battery cell BC to the pair of locked portions 41, thereby applying the pressing force from the pressing portion 42 to the temperature sensor unit 30. Accordingly, the pressing member 40 presses the temperature sensor unit 30 against the battery cell BC. The pressing portion 42 illustrated here is brought into contact with the other flat surface 23b (FIG. 5) of the temperature detection branch body 23 to apply the pressing force to the other flat surface 23b. In addition, the pair of locked portions 41 illustrated here is locked in the housing member 50.

In addition to the pair of locked portions 41 and the pressing portion 42, the pressing member 40 has a plurality of flat plate portions that have flat surfaces orthogonal to an action direction of the pressing force of the pressing portion 42 against the temperature sensor unit 30 and are arranged on the same flat surface. The pressing portion 42 protrudes toward the battery cell BC from the plurality of flat plate portions. Here, the plurality of flat plate portions are formed in a rectangular shape.

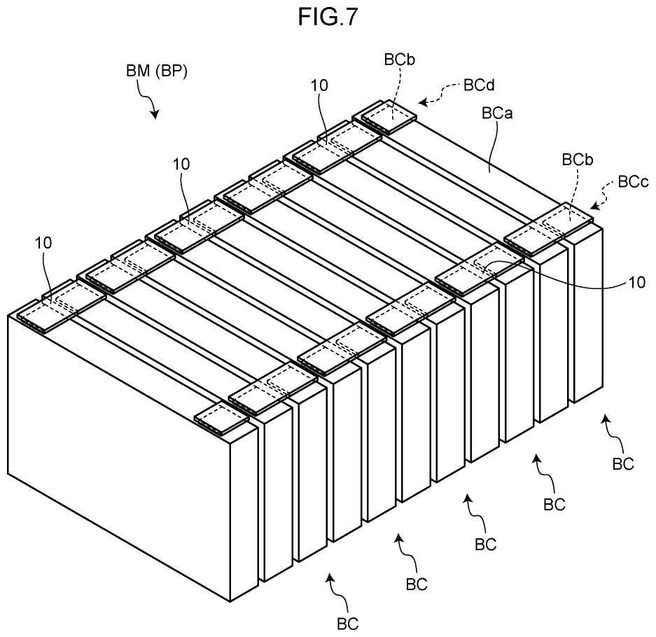

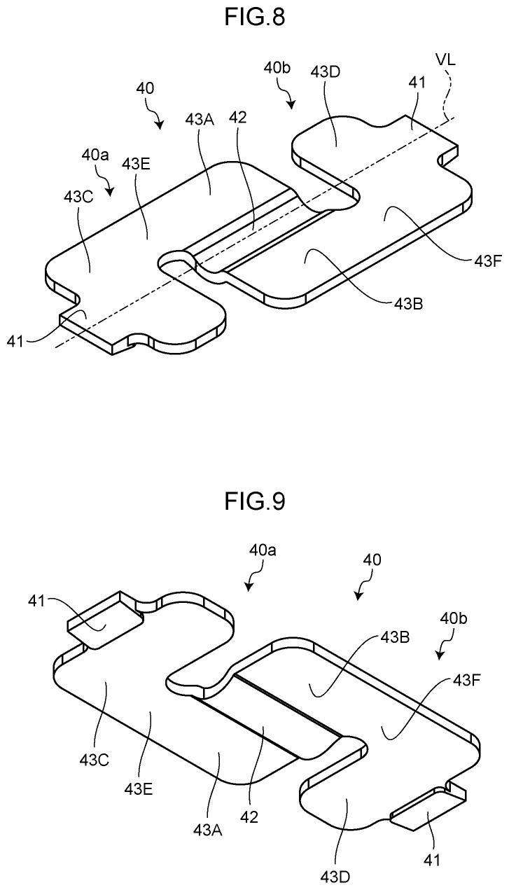

The plurality of flat plate portions include a first flat plate portion 43A and a second flat plate portion 43B disposed with the pressing portion 42 interposed therebetween in a direction orthogonal to a facing arrangement direction of the pair of locked portions 41 and the action direction of the pressing force of the pressing portion 42 (FIGS. 8 to 10).

Unless otherwise specifically mentioned hereinafter, the term “facing arrangement direction” refers to the facing arrangement direction of the pair of locked portions 41. In addition, unless otherwise specifically mentioned hereinafter, the term “orthogonal direction” refers to a direction orthogonal to the facing arrangement direction of the pair of locked portions 41 and the action direction of the pressing force of the pressing portion 42.

The first flat plate portion 43A and the second flat plate portion 43B are formed in the same rectangular shape, and are arranged with their side portions facing each other in the orthogonal direction. The pressing portion 42 is interposed between the respective side portions of the first flat plate portion 43A and the second flat plate portion 43B, and is connected to the respective side portions. The pressing portion 42 illustrated here is formed in an arcuate cross-sectional shape whose cross section orthogonal to the facing arrangement direction (in other words, a direction in which the pair of locked portions 41 and the pressing portion 42 are arranged) is convex toward the battery cell BC side.

Further, the plurality of flat plate portions include a third flat plate portion 43C located on one locked portion 41 side and disposed to be spaced apart from the pressing portion 42, the first flat plate portion 43A, and the second flat plate portion 43B, and a fourth flat plate portion 43D located on the other locked portion 41 side and disposed to be spaced apart from the pressing portion 42, the first flat plate portion 43A, and the second flat plate portion 43B (FIGS. 8 to 10). The third flat plate portion 43C and the fourth flat plate portion 43D are formed to have the same rectangular shape. The one locked portion 41 protrudes from the third flat plate portion 43C to a side opposite to the pressing portion 42 side. The other locked portion 41 protrudes from the fourth flat plate portion 43D toward a side opposite to the pressing portion 42 side. Each of the locked portions 41 is formed to have a piece shape.

The plurality of flat plate portions further include a fifth flat plate portion 43E that protrudes from the first flat plate portion 43A toward the third flat plate portion 43C in the facing arrangement direction to connect first flat plate portion 43A to the third flat plate portion 43C, and a sixth flat plate portion 43F that protrudes from the second flat plate portion 43B toward the fourth flat plate portion 43D in the facing arrangement direction to connect the second flat plate portion 43B to the fourth flat plate portion 43D (FIGS. 8 to 10). The fifth flat plate portion 43E and the sixth flat plate portion 43F are formed to have the same rectangular shape.

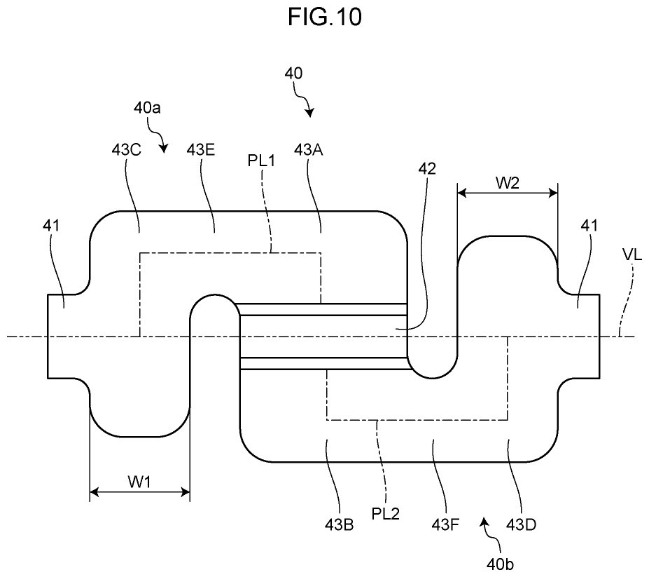

In the pressing member 40, a first spring portion 40a having a J-shape or a U-shape formed by the first flat plate portion 43A, the third flat plate portion 43C, and the fifth flat plate portion 43E, and a second spring portion 40b having a J-shape or a U-shape formed by the second flat plate portion 43B, the fourth flat plate portion 43D, and the sixth flat plate portion 43F are formed (FIGS. 8 to 10). The pressing member 40 bends the first spring portion 40a and the second spring portion 40b by applying pressing force toward the battery cell BC to the pair of locked portions 41, thereby generating pressing force of the pressing portion 42 against the temperature sensor unit 30. The pressing member 40 adjusts a magnitude of the pressing force of the pressing portion 42 by adjusting a J-shaped or U-shaped path length PL1 from the first flat plate portion 43A to the third flat plate portion 43C in the first spring portion 40a and a J-shaped or U-shaped path length PL2 from the second flat plate portion 43B to the fourth flat plate portion 43D in the second spring portion 40b (FIG. 10). The pressing force is adjusted to, for example, a magnitude that can keep the temperature sensor unit 30 in contact with the battery cell BC without impairing durability of the temperature sensor unit 30 and the pressing member 40 and even if external force such as running vibration of a vehicle acts or the battery cell BC is inclined.

Further, in addition to the path lengths PL1 and PL2 of the pressing member 40, a width W1 of the third flat plate portion 43C in the facing arrangement direction and a width W2 of the fourth flat plate portion 43D in the facing arrangement direction may be adjusted to a size capable of securing sufficient rigidity to suppress bending deformation of the third flat plate portion 43C and the fourth flat plate portion 43D, thereby adjusting the magnitude of the pressing force of the pressing portion 42 (FIG. 10). As a result, the pressing member 40 causes the first spring portion 40a and the second spring portion 40b to be mainly bent and deformed at the fifth flat plate portion 43E and the sixth flat plate portion 43F, thereby making it possible to appropriately transmit force resulting from the bending deformation to the pressing portion 42.

The temperature sensor unit 30 and the pressing member 40 are housed in the wiring housing chamber 52 of the housing member 50.

A through hole 53 for exposing the temperature sensor unit 30 to the battery cell BC side and bringing the temperature sensor unit 30 into contact with the battery cell BC is formed in a bottom portion 52a of the wiring housing chamber 52 (FIGS. 3, 5, and 6).

Further, a positioning pin 54 for positioning the temperature detection branch body 23 is formed on the bottom portion 52a (FIG. 5). A positioning hole 23c into which the positioning pin 54 is fitted is formed in the temperature detection branch body 23 (FIG. 5). Here, two positioning pins 54 are formed at peripheral edge portions of the through hole 53 in the bottom portion 52a, and two positioning holes 23c are formed with an assembly position of the battery cell BC and the frame member 32 in the temperature detection branch body 23 therebetween.

On the bottom portion 52a of the wiring housing chamber 52, a holding portion 55 that holds the locked portion 41 is provided in a protruding state for each locked portion 41 (FIGS. 3 to 6). A housing space 55a into which the locked portion 41 is inserted is formed in the holding portion 55 (FIGS. 5 and 6). Then, a locking portion (hereinafter, referred to as a “first locking portion”) 56 that locks the locked portion 41 by contacting the locked portion 41 in the housing space 55a from the side opposite to the battery cell BC is formed in the holding portion 55 (FIGS. 5 and 6). Further, locking portions (hereinafter, referred to as “second locking portions”) 57 that lock movement in the orthogonal direction of the locked portion 41 in the housing space 55a are formed at two locations in the holding portion 55 (FIG. 5). The locked portion 41 is held by the first locking portion 56 and the pair of second locking portions 57 in the housing space 55a in the holding portion 55.

Here, the first locking portion 56 locks the locked portion 41 in a state in which the pressing portion 42 is in contact with the temperature sensor unit 30 and the temperature sensor unit 30 is in contact with the battery cell BC, and applies pressing force toward the battery cell BC to the locked portion 41. In the housing member 50, the first locking portion 56 is formed for each locked portion 41. In the pressing member 40, the first spring portion 40a and the second spring portion 40b are bent by applying pressing force from each of the first locking portions 56 to the locked portion 41. As a result, the pressing member 40 can apply the pressing force to the temperature sensor unit 30 from the pressing portion 42 disposed on the same line between the two locked portions 41 by using the spring force resulting from bending deformation of the first spring portion 40a and the second spring portion 40b. For example, by applying pressing force evenly from each of the first locking portions 56 to the locked portion 41, the pressing member 40 forms a convex mountain shape protruding in a direction opposite to the battery cell BC side.

The conductive module 1 includes a cover member 60 assembled with the housing member 50 in order to cover the bus bar 10, the wiring component 20, the temperature sensor unit 30, and the pressing member 40 housed in the housing member 50 (FIGS. 1 and 2).

As described above, in the conductive module 1 according to the present embodiment, the pair of locked portions 41 and the pressing portion 42 are provided on the same line in the plate-shaped pressing member 40, and it is possible to reduce the size of the pressing member 40 in the action direction of pressing force as compared with a pressing member of the related art. Therefore, the conductive module 1 according to the present embodiment can reduce a height. Accordingly, it is also possible to contribute to reducing a height of the battery pack BP. In addition, since the height of the conductive module 1 according to the present embodiment is reduced, a size of each battery cell BC can be increased by the reduced size, so that a capacity (that is, a battery capacity) of the battery module BM can be increased, a cruising range can be extended, and an output of a rotary machine can be increased.

Furthermore, in the conductive module 1 according to the present embodiment, the pair of locked portions 41 and the pressing portion 42 are provided on the same line in the plate-shaped pressing member 40, and an orthogonal cross section of the pressing portion 42 with respect to a direction in which the pair of locked portions 41 and the pressing portion 42 are arranged is formed in an arcuate cross-sectional shape protruding toward the battery cell BC side. Therefore, in the conductive module 1, even if the battery cell BC is inclined around an axis having the arrangement direction as the axis due to running vibration of the vehicle or the like, the pressing member 40 follows movement thereof by the spring force of the first spring portion 40a and the second spring portion 40b, thereby enabling the temperature sensor unit 30 to be kept in contact with the battery cell BC with the pressing force of the pressing portion 42. Therefore, the conductive module 1 according to the present embodiment can suppress deterioration in temperature detection accuracy of the battery cell BC.

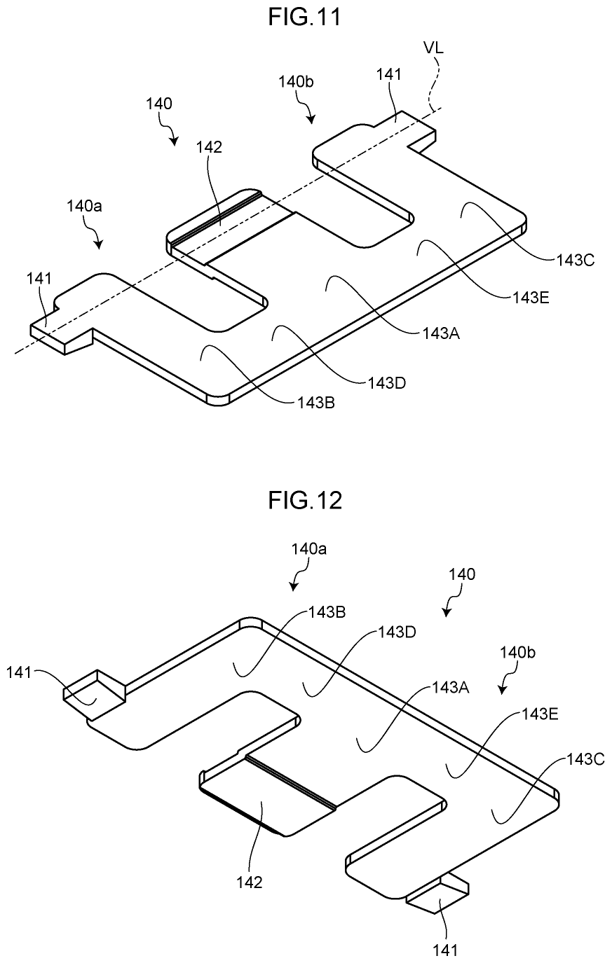

Meanwhile, in the conductive module 1 according to the present embodiment, the pressing member 40 may be replaced with the following pressing member 140 (FIGS. 11 to 13).

Similarly to the pressing member 40, the pressing member 140 includes a pair of locked portions 141 and a pressing portion 142 disposed on the same line (FIGS. 11 to 13).

Further, similarly to the pressing member 40, the pressing member 140 has a plurality of flat plate portions arranged on the same flat surface. The plurality of flat plate portions are formed in a rectangular shape.

The plurality of flat plate portions include a first flat plate portion 143A protruding from the pressing portion 142 in a direction orthogonal to the facing arrangement direction of the pair of locked portions 141 and the action direction of the pressing force of the pressing portion 142 (FIGS. 11 to 13). The pressing portion 142 illustrated here protrudes toward the battery cell BC from the first flat plate portion 143A while maintaining a flat plate shape. Note that the pressing portion 142 may be formed in an arcuate cross-sectional shape whose cross section orthogonal to the facing arrangement direction (In other words, a direction in which the pair of locked portions 141 and the pressing portion 142 are arranged) is convex toward the battery cell BC side, similarly to the above-described pressing portion 42.

Further, the plurality of flat plate portions include a second flat plate portion 143B located on one locked portion 141 side and disposed to be spaced apart from the pressing portion 142 and the first flat plate portion 143A, and a third flat plate portion 143C located on the other locked portion 141 side and disposed to be spaced apart from the pressing portion 142 and the first flat plate portion 143A (FIGS. 11 to 13). The second flat plate portion 143B and the third flat plate portion 143C are formed in the same rectangular shape. The one locked portion 141 protrudes from the second flat plate portion 143B to a side opposite to the pressing portion 142 side. The other locked portion 141 protrudes from the third flat plate portion 143C toward a side opposite to the pressing portion 142 side. Each of the locked portions 141 is formed in a one-sided support shape.

Furthermore, the plurality of flat plate portions include a fourth flat plate portion 143D that protrudes from an end on a protruding direction side of the first flat plate portion 143A toward the second flat plate portion 143B in the facing arrangement direction to connect the first flat plate portion 143A to the second flat plate portion 143B, and a fifth flat plate portion 143E that protrudes from an end on the protruding direction side of the first flat plate portion 143A toward the third flat plate portion 143C in the facing arrangement direction to connect the first flat plate portion 143A to the third flat plate portion 143C (FIGS. 11 to 13). The fourth flat plate portion 143D and the fifth flat plate portion 143E are formed to have the same rectangular shape.

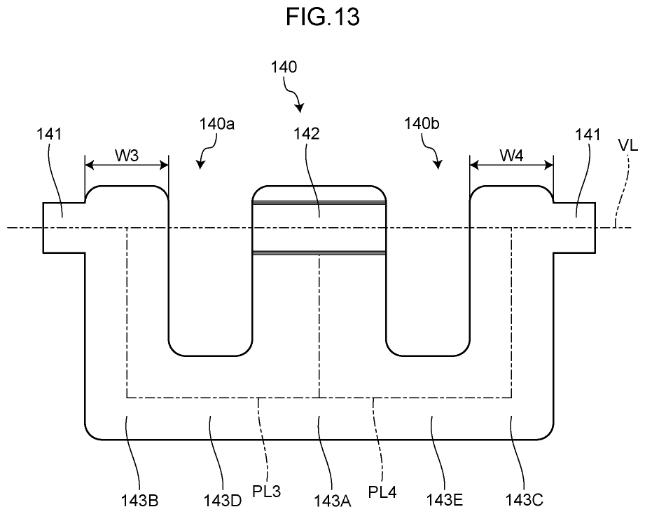

In the pressing member 140, a first spring portion 140a having a J-shape or a U-shape formed by the first flat plate portion 143A, the second flat plate portion 143B, and the fourth flat plate portion 143D, and a second spring portion 140b having a J-shape or a U-shape formed by the first flat plate portion 143A, the third flat plate portion 143C, and the fifth flat plate portion 143E are formed (FIGS. 11 to 13). The pressing member 140 bends the first spring portion 140a and the second spring portion 140b by applying pressing force toward the battery cell BC to the pair of locked portions 141, thereby generating pressing force of the pressing portion 142 against the temperature sensor unit 30. The pressing member 140 adjusts a magnitude of the pressing force of the pressing portion 142 by adjusting a J-shaped or U-shaped path length PL3 from the first flat plate portion 143A to the second flat plate portion 143B in the first spring portion 140a and a J-shaped or U-shaped path length PL4 from the first flat plate portion 143A to the third flat plate portion 143C in the second spring portion 140b (FIG. 13). The pressing force is adjusted to, for example, the same magnitude as that of the previous pressing member 40.

Further, in addition to the path lengths PL3 and PL4 of the pressing member 140, a width W3 of the second flat plate portion 143B in the facing arrangement direction and a width W4 of the third flat plate portion 143C in the facing arrangement direction may be adjusted to a size capable of securing sufficient rigidity to suppress bending deformation of the second flat plate portion 143B and the third flat plate portion 143C, thereby adjusting the magnitude of the pressing force of the pressing portion 142 (FIG. 13). As a result, the pressing member 140 causes the first spring portion 140a and the second spring portion 140b to be mainly bent and deformed at the fourth flat plate portion 143D and the fifth flat plate portion 143E, thereby making it possible to appropriately transmit force resulting from the bending deformation to the pressing portion 142.

In the conductive module 1 according to the present embodiment, even if the pressing member 40 is replaced with the pressing member 140, the conductive module 1 can obtain a similar effect using the pressing member 40.

In a conductive module according to the present embodiment, a pair of locked portions and a pressing portion are provided on the same line in a plate-shaped pressing member, and it is possible to reduce a size of the pressing member in an action direction of pressing force as compared with a pressing member of the related art. Therefore, the conductive module according to the present embodiment can reduce a height. Accordingly, it is possible to contribute to reducing a height of a battery pack. In addition, since the height of the conductive module according to the present embodiment is reduced, a size of each battery cell can be increased by the reduced size, so that a capacity (that is, a battery capacity) of a battery module can be increased, a cruising range can be extended, and an output of a rotary machine can be increased.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
a wiring component provided with a plurality of conductor portions electrically connecting a battery module to a battery monitoring unit, the battery module having a plurality of battery cells arranged therein in a row, the battery monitoring unit being configured to monitor battery states of the battery cells;
a temperature sensor unit configured to detect a temperature of the battery cell;
a plate-shaped pressing member configured to press the temperature sensor unit against the battery cell; and
a housing member configured to house therein the wiring component, the temperature sensor unit, and the pressing member, wherein
the wiring component includes a wiring main body extending in an arrangement direction of the battery cells, a temperature detection branch body branching from the wiring main body toward the battery cell as a temperature detection target, and a temperature detection conductor portion serving as the conductor portion, the temperature detection conductor portion being electrically connected to the temperature sensor unit,
the temperature sensor unit includes the temperature detection branch body, a temperature sensor physically and electrically connected to the temperature detection conductor portion of the temperature detection branch body, and a frame-shaped frame member configured for the temperature sensor to be disposed on an inner side thereof such that the temperature sensor is surrounded by the frame member,
the pressing member includes a pair of locked portions disposed to face each other with a space therebetween, and a pressing portion provided on a virtual line connecting the pair of locked portions, the pressing portion pressing the temperature sensor unit against the battery cell, and
the housing member includes, for each locked portion, a locking portion adapted to lock the locked portion in a state in which the pressing portion is in contact with the temperature sensor unit and the temperature sensor unit is in contact with the battery cell, the locking portion being adapted to apply pressing force toward the battery cell to the locked portion.

2. The conductive module according to claim 1, wherein
the pressing member includes a plurality of flat plate portions having flat surfaces orthogonal to an action direction of pressing force of the pressing portion against the temperature sensor unit, the flat plate portions being disposed on the same flat surface, the pair of locked portions, and the pressing portion protruding toward the battery cell from the plurality of flat plate portions,
the plurality of flat plate portions include a first flat plate portion and a second flat plate portion disposed with the pressing portion interposed therebetween in a direction orthogonal to a facing arrangement direction of the pair of locked portions and the action direction of the pressing force of the pressing portion, a third flat plate portion located on one locked portion side and disposed to be spaced apart from the pressing portion, the first flat plate portion, and the second flat plate portion, a fourth flat plate portion located on the other locked portion side and disposed to be spaced apart from the pressing portion, the first flat plate portion, and the second flat plate portion, and a fifth flat plate portion protruding from the first flat plate portion toward the third flat plate portion in the facing arrangement direction to connect the first flat plate portion to the third flat plate portion, and a sixth flat plate portion protruding from the second flat plate portion toward the fourth flat plate portion in the facing arrangement direction to connect the second flat plate portion to the fourth flat plate portion,
one of the locked portions protrudes from the third flat plate portion to a side opposite to the pressing portion side, and
the other locked portion protrudes from the fourth flat plate portion to a side opposite to the pressing portion side.

3. The conductive module according to claim 2, wherein
the pressing member generates the pressing force of the pressing portion against the temperature sensor unit by bending a first spring portion having a J-shape or a U-shape formed by the first flat plate portion, the third flat plate portion, and the fifth flat plate portion, and a second spring portion having a J-shape or a U-shape formed by the second flat plate portion, the fourth flat plate portion, and the sixth flat plate portion by applying the pressing force applied to the pair of locked portions.

4. The conductive module according to claim 3, wherein
the plurality of flat plate portions are formed in a rectangular shape, and
the pressing member adjusts a magnitude of the pressing force by adjusting a J-shaped or U-shaped path length from the first flat plate portion to the third flat plate portion in the first spring portion and a J-shaped or U-shaped path length from the second flat plate portion to the fourth flat plate portion in the second spring portion.

5. The conductive module according to claim 1, wherein
the pressing member includes a plurality of flat plate portions having flat surfaces orthogonal to an action direction of pressing force of the pressing portion against the temperature sensor unit, the flat plate portions being disposed on the same flat surface, the pair of locked portions, and the pressing portion protruding toward the battery cell from the plurality of flat plate portions,
the plurality of flat plate portions include a first flat plate portion protruding from the pressing portion in a direction orthogonal to a facing arrangement direction of the pair of locked portions and the action direction of the pressing force of the pressing portion, a second flat plate portion located on one locked portion side and disposed to be spaced apart from the pressing portion and the first flat plate portion, a third flat plate portion located on the other locked portion side and disposed to be spaced apart from the pressing portion and the first flat plate portion, a fourth flat plate portion protruding from an end on a protruding direction side of the first flat plate portion toward the second flat plate portion in the facing arrangement direction to connect the first flat plate portion to the second flat plate portion, and a fifth flat plate portion protruding from the end of the first flat plate portion toward the third flat plate portion in the facing arrangement direction to connect the first flat plate portion to the third flat plate portion,
one of the locked portions protrudes from the second flat plate portion to a side opposite to the pressing portion side, and
the other locked portion protrudes from the third flat plate portion to a side opposite to the pressing portion side.

6. The conductive module according to claim 5, wherein
the pressing member generates the pressing force of the pressing portion against the temperature sensor unit by bending a first spring portion having a J-shape or a U-shape formed by the first flat plate portion, the second flat plate portion, and the fourth flat plate portion, and a second spring portion having a J-shape or a U-shape formed by the first flat plate portion, the third flat plate portion, and the fifth flat plate portion.

7. The conductive module according to claim 6, wherein
the plurality of flat plate portions are formed in a rectangular shape, and
the pressing member adjusts a magnitude of the pressing force by adjusting a J-shaped or U-shaped path length from the first flat plate portion to the second flat plate portion in the first spring portion and a J-shaped or U-shaped path length from the first flat plate portion to the third flat plate portion in the second spring portion.

8. The conductive module according to claim 1, further comprising:
a bus bar housed in the housing member, the bus bar being physically and electrically connected to an electrode terminal of one or a pair of the battery cells in the battery module, wherein
the wiring component includes a voltage detection conductor portion for each of the bus bars as the conductor portion, the voltage detection conductor portion electrically connecting the bus bar to the battery monitoring unit.

9. The conductive module according to claim 2, further comprising:
a bus bar housed in the housing member, the bus bar being physically and electrically connected to an electrode terminal of one or a pair of the battery cells in the battery module, wherein
the wiring component includes a voltage detection conductor portion for each of the bus bars as the conductor portion, the voltage detection conductor portion electrically connecting the bus bar to the battery monitoring unit.

10. The conductive module according to claim 3, further comprising:
a bus bar housed in the housing member, the bus bar being physically and electrically connected to an electrode terminal of one or a pair of the battery cells in the battery module, wherein
the wiring component includes a voltage detection conductor portion for each of the bus bars as the conductor portion, the voltage detection conductor portion electrically connecting the bus bar to the battery monitoring unit.

11. The conductive module according to claim 4, further comprising:
a bus bar housed in the housing member, the bus bar being physically and electrically connected to an electrode terminal of one or a pair of the battery cells in the battery module, wherein
the wiring component includes a voltage detection conductor portion for each of the bus bars as the conductor portion, the voltage detection conductor portion electrically connecting the bus bar to the battery monitoring unit.

12. The conductive module according to claim 5, further comprising:
a bus bar housed in the housing member, the bus bar being physically and electrically connected to an electrode terminal of one or a pair of the battery cells in the battery module, wherein
the wiring component includes a voltage detection conductor portion for each of the bus bars as the conductor portion, the voltage detection conductor portion electrically connecting the bus bar to the battery monitoring unit.

13. The conductive module according to claim 6, further comprising:
a bus bar housed in the housing member, the bus bar being physically and electrically connected to an electrode terminal of one or a pair of the battery cells in the battery module, wherein
the wiring component includes a voltage detection conductor portion for each of the bus bars as the conductor portion, the voltage detection conductor portion electrically connecting the bus bar to the battery monitoring unit.

14. The conductive module according to claim 7, further comprising:
a bus bar housed in the housing member, the bus bar being physically and electrically connected to an electrode terminal of one or a pair of the battery cells in the battery module, wherein
the wiring component includes a voltage detection conductor portion for each of the bus bars as the conductor portion, the voltage detection conductor portion electrically connecting the bus bar to the battery monitoring unit.
